(19) United States
(12) Patent Application Publication
(10) Pub. No.: US 2017/0010042 A1
(43) Pub. Date: Jan. 12, 2017

(54) System and Method for the Production of Liquefied Natural Gas

(71) Applicants: Jason M. KERTH, Houston, TX (US); DRESSER-RAND COMPANY, Olean, NY (US)

(72) Inventor: Jason M. Kerth, Houston, TX (US)

(73) Assignee: DRESSER-RAND COMPANY, Olean, NY (US)

(21) Appl. No.: 14/888,748

(22) PCT Filed: Mar. 13, 2015
(86) PCT No.: PCT/US15/20318

§ 371 Date: Nov. 3, 2015

Related U.S. Application Data
(60) Provisional application No. 61/973,972, filed on Apr. 2, 2014.

(51) Int. Cl. F25J 1/02; F02B 63/04; H02K 7/18; F25J 1/00

(52) U.S. Cl. CPC F25J 1/023; F25J 1/0012; F25J 1/0037; F25J 1/004; F25J 1/0052; F25J 1/0208; F25J 1/0227; F25J 1/0242; F25J 1/0264; F25J 1/0284; F25J 1/0288; F02B 63/04; H02K 7/1815; F25J 2210/06; F25J 2220/66

(57) ABSTRACT

A method for producing liquefied natural gas (LNG) is provided. The method may include feeding natural gas from a high-pressure natural gas source to a separator and removing a non-hydrocarbon from the natural gas. A portion of the natural gas from the separator may be precooled, and the precooled natural gas may be cooled in a first heat exchanger with a first refrigeration stream. A first portion of the cooled natural gas may be expanded in a turbo-expander to generate the first refrigeration stream. A second portion of the cooled natural gas may be cooled in a second heat exchanger with the first refrigeration stream and expanded in an expansion valve to produce a two-phase fluid containing the LNG and a vapor phase. The LNG may be separated from the vapor phase in a liquid separator and stored in a storage tank.

### CROSS REFERENCE TO RELATED APPLICATIONS

This application claims priority to U.S. Provisional patent application having Ser. No. 61/973,972, which was filed Apr. 2, 2014. The aforementioned patent application is hereby incorporated by reference in its entirety into the present application to the extent consistent with the present application.

### BACKGROUND

The combustion of conventional fuels, such as gasoline and diesel, has proven to be essential in a myriad of industrial processes. The combustion of gasoline and diesel, however, may often be accompanied by various drawbacks including increased production costs and increased carbon emissions. In view of the foregoing, recent efforts have focused on alternative fuels with decreased carbon emissions, such as natural gas, to combat the drawbacks of combusting conventional fuels. In addition to providing a “cleaner” alternative fuel with decreased carbon emissions, combusting natural gas may also be relatively safer than combusting conventional fuels. For example, the relatively low density of natural gas allows it to safely and readily dissipate to the atmosphere in the event of a leak. In contrast, conventional fuels (e.g., gasoline and diesel) have a relatively high density and tend to settle or accumulate in the event of a leak, which may present a hazardous and/or fatal working environment for nearby operators.

While the utilization of natural gas may address some of the drawbacks associated with conventional fuels, the storage and transport of natural gas in sufficient quantities may prevent it from being viewed as a viable alternative to conventional fuels. For example, the storage and/or transport of natural gas in appreciable quantities may be cost-prohibitive and/or impracticable due to its relatively low density. Accordingly, natural gas is routinely converted into liquefied natural gas (LNG) at an LNG plant and transported from the LNG plant to the end user or customer via tanker trucks. The availability of LNG, however, may often be limited by the proximity of the customer to the LNG plant. For example, customers that are remotely located from the LNG plant may often rely on deliveries from the tanker trucks, which may increase the cost of utilizing LNG. Additionally, remotely located customers may often be required to maintain larger, cost-prohibitive storage tanks to reduce the frequency of the deliveries and/or their dependence on the tanker trucks. In lieu of LNG, remotely located customers may opt to utilize local natural gas pipelines to produce compressed natural gas (CNG) on-site. CNG, similar to natural gas, has a lower relative density than LNG; and thus, the storage of CNG in appreciable quantities may also be cost-prohibitive and/or impracticable.

What is needed, then, is a system and method for producing LNG from natural gas pipelines and stranded wells.

### SUMMARY

Embodiments of the disclosure may provide a method for producing liquefied natural gas from a high-pressure natural gas source. The method may include feeding natural gas from the high-pressure natural gas source to a separator and removing a non-hydrocarbon from the natural gas in the separator. The method may also include precooling a portion of the natural gas from the separator in a cooling assembly. The method may further include cooling the precooled natural gas from the cooling assembly in a first heat exchanger with a first refrigeration stream, and expanding a first portion of the cooled natural gas from the first heat exchanger in a turbo-expander to generate the first refrigeration stream. The method may also include cooling a second portion of the cooled natural gas from the first heat exchanger in a second heat exchanger with the first refrigeration stream. The method may further include expanding the second portion of the cooled natural gas from the second heat exchanger in an expansion valve to provide a two-phase fluid containing the liquefied natural gas and a vapor phase. The method may further include separating the liquefied natural gas from the vapor phase in a liquid separator, and storing the liquefied natural gas in a storage tank.

Embodiments of the disclosure may also provide another method for producing liquefied natural gas from a high-pressure natural gas source. The method may include feeding natural gas from the high-pressure natural gas source to a conditioning assembly. The method may also include removing a non-hydrocarbon from the natural gas in the conditioning assembly. The method may further include precooling a first portion of the natural gas from the conditioning assembly in a precooling assembly, and cooling the precooled natural gas from the precooling assembly in a first heat exchanger with a first refrigeration stream. The method may also include expanding a first portion of the cooled natural gas from the first heat exchanger in a turbo-expander to generate the first refrigeration stream. The method may also include cooling a second portion of the cooled natural gas from the first heat exchanger in a second heat exchanger with the first refrigeration stream. The method may further include expanding the second portion of the cooled natural from the second heat exchanger in an expansion valve to produce a two-phase fluid containing the liquefied natural gas and a vapor phase, separating the liquefied natural gas from the vapor phase in a first liquid separator, and storing the liquefied natural gas in a storage tank. The method may also include feeding the vapor phase from the liquid separator to a third heat exchanger to provide a second refrigeration stream to the third heat exchanger. The method may further include cooling a second portion of the natural gas from the conditioning assembly in the third heat exchanger with the second refrigeration stream. The method may also include distributing the natural gas from the conditioning assembly to the precooling assembly and the third heat exchanger via a flow control valve.

Embodiments of the disclosure may further provide a system for producing liquefied natural gas from a high-pressure natural gas source. The system may include a separator configured to receive natural gas from the high-pressure natural gas source and separate a non-hydrocarbon from the natural gas. A cooling assembly may be fluidly coupled with and disposed downstream from the separator and configured to precool the natural gas from the separator. A first heat exchanger may be fluidly coupled with and disposed downstream from the cooling assembly. The first heat exchanger may be configured to receive a first refrigeration stream and cool the precooled natural gas from the cooling assembly with the first refrigeration stream. The system may also include a turbo-expander fluidly coupled with and disposed downstream from the first heat exchanger. The turbo-expander may be configured to expand a first portion of the cooled natural gas from the first heat exchanger to generate the first refrigeration stream. A second heat exchanger may be fluidly coupled with and disposed downstream from the first heat exchanger and the turbo-expander. The second heat exchanger may be configured to receive the first refrigeration stream from the turbo-expander and cool a second portion of the cooled natural gas from the first heat exchanger with the first refrigeration stream. The system may further include an expansion valve fluidly coupled with and disposed downstream from the second heat exchanger. The expansion valve may be configured to receive and expand the second portion of the cooled natural gas from the second heat exchanger to produce a two-phase fluid containing the liquefied natural gas and a vapor phase. A liquid separator may be fluidly coupled with the expansion valve and configured to separate the liquefied natural gas from the vapor phase. A storage tank may be fluidly coupled with the liquid separator and configured to receive and store the liquefied natural gas from the liquid separator.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a process flow diagram of a system for producing liquefied natural gas (LNG) from a natural gas source, according to one or more embodiments disclosed.

FIG. 2 illustrates a flowchart of a method for producing liquefied natural gas from a high-pressure natural gas source, according to one or more embodiments disclosed.

FIG. 3 illustrates a flowchart of another method for producing liquefied natural gas from a high-pressure natural gas source, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

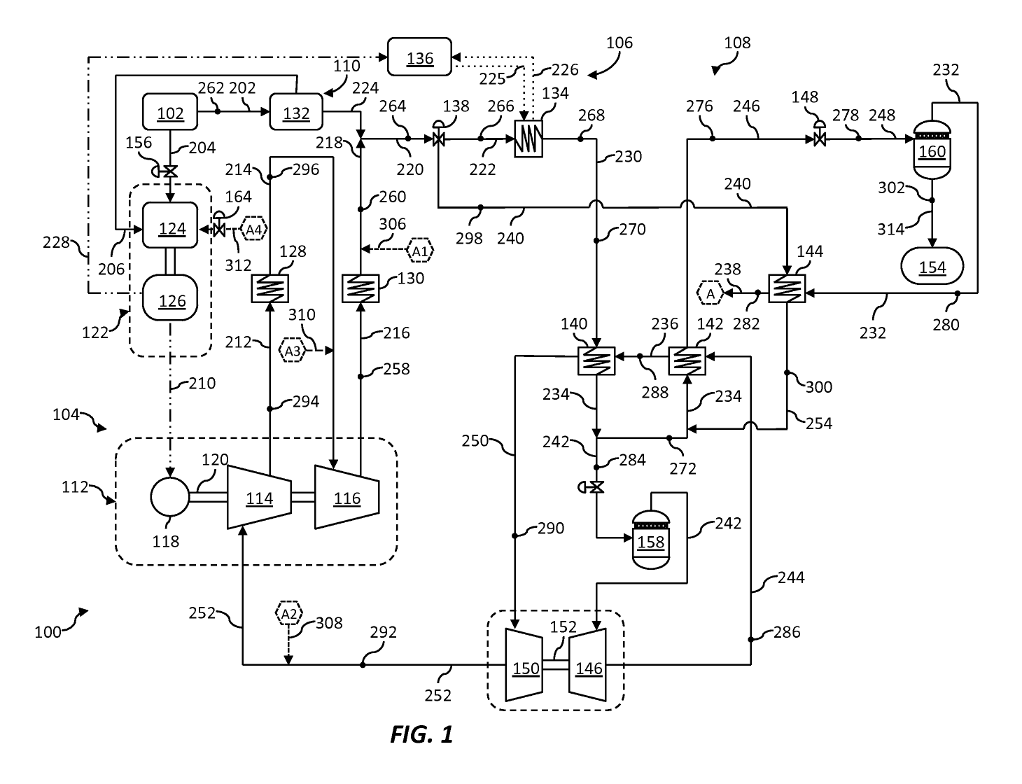

FIG. 1 illustrates a process flow diagram of a system 100 for producing compressed natural gas (CNG), cold compressed natural gas (CCNG), and/or liquefied natural gas (LNG) from a natural gas source 102, according to one or more embodiments. In least one embodiment, the system 100 may include a compression assembly 104, a cooling assembly 106, and a liquefaction assembly 108 coupled with and/or in thermal communication with one another. The system 100 may be configured to circulate a process stream containing natural gas from the natural gas source 102 to one or more portions or assemblies thereof. For example, as illustrated in FIG. 1, the system 100 may be fluidly coupled with the natural gas source 102 via line 202 and configured to circulate the process stream containing the natural gas from the natural gas source 102 to the compression assembly 104, the cooling assembly 106, and/or the liquefaction assembly 108.

In one or more portions or assemblies of the system 100, the natural gas in the process stream may be in a liquid phase, a gaseous phase, a fluid phase, a subcritical state, a supercritical state, or any other phases or states, or any combination thereof. For example, as further described herein, the natural gas may be in the gaseous phase in the compression assembly 104 and/or the cooling assembly 106. In another example, as further described herein, the liquefaction assembly 108 may cool the natural gas from the gaseous phase to the subcritical state (e.g., LNG).

In at least one embodiment, the natural gas source 102 may be or include a natural gas pipeline, a stranded natural gas wellhead, or the like, or any combination thereof. For example, the natural gas source 102 may be a low-pressure natural gas pipeline or a high-pressure natural gas pipeline. In at least one embodiment, the high-pressure natural gas pipeline may contain natural gas at a pressure from a low of about 2500 kPa, about 2600 kPa, about 2700 kPa, about 2800 kPa, about 3000 kPa, about 3500 kPa, about 4000 kPa, about 5000 kPa, or about 6000 kPa to a high of about 7000 kPa, about 8000 kPa, about 9000 kPa, about 9500 kPa, about 10,000 kPa, about 10,200 kPa, about 10,300 kPa, about 10,400 kPa, about 10,500 kPa, or greater. The natural gas source 102 may contain natural gas at ambient temperature. The natural gas from the natural gas source 102 may include one or more hydrocarbons. For example, the natural gas may include methane, ethane, propane, butanes, pentanes, or the like, or any combination thereof. Methane may be a major component of the natural gas. For example, the concentration of methane in the natural gas from the natural gas source 102 may be greater than about 80%, greater than about 85%, greater than about 90%, or greater than about 95%. In at least one embodiment, the natural gas from the natural gas source 102 may be or include a mixture of one or more hydrocarbons (e.g., methane, ethane, etc.) and one or more non-hydrocarbons. Illustrative non-hydrocarbons may include, but are not limited to, water, carbon dioxide (CO₂), hydrogen sulfide, helium, nitrogen, or the like, or any combination thereof.

In at least one embodiment, the compression assembly 104 may include one or more compressors (one is shown 112) configured to compress and/or pressurize the process stream flowing through the system 100. Illustrative compressors 112 may include, but are not limited to, supersonic compressors, centrifugal compressors, axial flow compressors, reciprocating compressors, rotating screw compressors, rotary vane compressors, scroll compressors, diaphragm compressors, or the like, or any combination thereof. In at least one embodiment, the compressor 112 may include one or more compressor stages (two are shown 114, 116) coupled with one another and one or more drivers or motors (one is shown 118) coupled with and configured to drive the compressor stages 114, 116. For example, as illustrated in FIG. 1, a first compressor stage 114 may be coupled with a second compressor stage 116 via a driveshaft 120, and the driver 118 may be coupled with and configured to drive the first and second compressor stages 114, 116 via the driveshaft 120. Illustrative drivers 118 may include, but are not limited to, electric motors, turbines, internal combustion engines, and/or any other devices capable of driving the compressor 112 or the compressor stages 114, 116 thereof. In an exemplary embodiment, illustrated in FIG. 1, the driver 118 may be an electric motor configured to receive and be driven by electrical energy.

In at least one embodiment, the system 100 may include a power generation system 122 configured to generate electrical energy to drive one or more components or assemblies of the system 100. For example, the power generation system 122 may be configured to generate electrical energy to drive the electric motor 118 of the compression assembly 104. As illustrated in FIG. 1, the power generation system 122 may include an internal combustion engine 124 and a generator 126 operably coupled with the internal combustion engine 124. In at least one embodiment, the internal combustion engine 124 may be fluidly coupled with the natural gas source 102 via line 204 and configured to receive and combust at least a portion of the natural gas from the natural gas source 102 to generate the mechanical energy. In another embodiment, the internal combustion engine 124 may be fluidly coupled with another component or assembly of the system 100 and configured to receive and combust the natural gas therefrom to generate mechanical energy. For example, as further described herein, the internal combustion engine 124 may receive and combust a regeneration gas from a separator 132 via line 206 to generate the mechanical energy. In another example, as further described herein, the internal combustion engine 124 may receive and combust a process stream (i.e., the second refrigeration stream) containing the natural gas from the liquefaction assembly 108 via line 312 to generate the mechanical energy. The generator 126 may be configured to convert the mechanical energy from the internal combustion engine 124 to electrical energy and deliver the electrical energy to the electric motor 118 via line 210 to thereby drive the electric motor 118 and the compressor 112.

In at least one embodiment, the compression assembly 104 may include one or more heat exchangers or coolers (two are shown 128, 130) configured to absorb or remove heat from the process stream flowing therethrough. The coolers 128, 130 may be fluidly coupled with the respective compressor stages 114, 116 and configured to remove thermal energy or heat generated in the compressor stages 114, 116. For example, compressing the process stream in the compressor stages 114, 116 may generate heat (e.g., heat of compression) in the process stream, and the coolers 128, 130 may be configured to remove the heat of compression from the process stream and/or the natural gas contained therein. In at least one embodiment, the coolers 128, 130 may be fluidly coupled with and disposed downstream from the respective compressor stages 114, 116 of the compressor 112. For example, a first cooler 128 may be fluidly coupled with and disposed downstream from the first compressor stage 114 via line 212, and a second cooler 130 may be fluidly coupled with and disposed downstream from the second compressor stage 116 via line 216. As further illustrated in FIG. 1, the first cooler 128 may be fluidly coupled with and disposed upstream of the second compressor stage via line 214.

In at least one embodiment, a heat transfer medium may flow through the coolers 128, 130 to absorb the heat in the process stream flowing therethrough. Accordingly, the heat transfer medium may have a higher temperature when it exits the coolers 128, 130, and the process stream may have a lower temperature when it exits the coolers 128, 130. The heat transfer medium may be or include water, steam, a refrigerant, a process gas, such as carbon dioxide, propane, or natural gas, or the like, or any combination thereof. In an exemplary embodiment, the heat transfer medium may be or include a refrigerant from the cooling assembly 106. In at least one embodiment, the heat transfer medium from the coolers 128, 130 may provide supplemental heating to one or more portions and/or assemblies of the system 100. For example, the heat transfer medium containing the heat absorbed from the coolers 128, 130 may provide supplemental heating to a heat recovery unit (HRU) (not shown).

As previously discussed, the natural gas from the natural gas source 102 may be or include a mixture of one or more hydrocarbons (e.g., methane, ethane, etc.) and one or more non-hydrocarbons (e.g., water, CO₂, hydrogen sulfide, etc.). In at least one embodiment, the system 100 may include a conditioning assembly 110 fluidly coupled with the natural gas source 102 and configured to at least partially separate or remove one or more of the non-hydrocarbons from the natural gas contained in the process stream flowing therethrough. The conditioning assembly 110 may include a separator 132 fluidly coupled with and disposed downstream from the natural gas source 102 via line 202. In at least one embodiment, the separator 132 may be configured to remove water and/or CO₂ from the natural gas in the process stream to increase the concentration of the hydrocarbons in the process stream and/or prevent the natural gas in the process stream from subsequently crystallizing (e.g., freezing) in one or more portions and/or downstream processes of the system 100. For example, in one or more portions and/or downstream processes of the system 100, the process stream may be cooled to or below a freezing point of one or more of the non-hydrocarbons (e.g., water and/or CO₂). Accordingly, removing water and/or CO₂ from the natural gas contained in the process stream may prevent the subsequent crystallization of the process stream in the system 100.

In at least one embodiment, the separator 132 may include or contain one or more adsorbents configured to separate the non-hydrocarbons from the natural gas in the process stream. The adsorbents may include, but are not limited to, one or more molecular sieves, zeolites, metal-organic frameworks, or the like, or any combination thereof. In at least one embodiment, the adsorbent, such as the molecular sieve, may be activated at varying temperatures and/or pressures. The adsorbent may have an adsorptive capacity determined by an amount of an adsorbate or the non-hydrocarbons (e.g., CO₂, water, etc.) separated by the adsorbent under predetermined conditions (e.g., temperature and/or pressure).

In at least one embodiment, the separator 132 and/or the adsorbent contained therein may be configured to separate the non-hydrocarbons from the process stream at a predetermined separation pressure. For example, the separator 132 and/or the adsorbent may be configured to separate the non-hydrocarbons (e.g., CO₂ and/or water) at a pressure from a low of about 2500 kPa, about 2600 kPa, about 2700 kPa, about 2800 kPa, about 3000 kPa, about 3500 kPa, about 4000 kPa, about 5000 kPa, or about 6000 kPa to a high of about 7000 kPa, about 8000 kPa, about 9000 kPa, about 9500 kPa, about 10,000 kPa, about 10,200 kPa, about 10,300 kPa, about 10,400 kPa, about 10,500 kPa, or greater. In at least one embodiment, the separator 132 and/or the adsorbent contained therein may be configured to separate the non-hydrocarbons from the process stream at a predetermined separation temperature. For example, the separator 132 and/or the adsorbent may be configured to separate the non-hydrocarbons (e.g., CO₂ and/or water) at a temperature from a low of about 10° C., about 15° C., about 20° C., about 25° C., or about 30° C. to a high of about 35° C., about 40° C., about 45° C., about 50° C., about 55° C., or greater. In an exemplary embodiment, the separator 132 may be configured to separate the non-hydrocarbons at ambient temperature.

In at least one embodiment, the non-hydrocarbons (e.g., CO₂ and/or water) may be desorbed from the adsorbent by directing or flowing a purge gas through the separator 132 to thereby regenerate the separator 132 and/or the adsorbent. As the purge gas flows through the separator 132, the non-hydrocarbons (e.g., CO₂ and/or water) may desorb from the adsorbent (e.g., molecular sieve) and combine with the purge gas to provide a regeneration gas including a mixture of the purge gas and the non-hydrocarbons. In an exemplary embodiment, the separator 132 and/or the adsorbant contained therein may be configured to adsorb CO₂ and/or water from the natural gas in the process stream. Accordingly, directing the purge gas through the separator 132 may provide a regeneration gas including a mixture of the purge gas, CO₂, and/or water. In at least one embodiment, the regeneration gas containing the mixture of the purge gas, CO₂, and/or water may be utilized as fuel for one or more processes or components of the system 100 to thereby increase the energy efficiency of the system 100. For example, as illustrated in FIG. 1, the regeneration gas from the separator 132 may be directed to the internal combustion engine 124 of the power generation system 122 via line 206 and utilized as fuel (e.g., supplemental fuel) therein.

In at least one embodiment, the cooling assembly 106 may include one or more heat exchangers (one is shown 134) configured to pre-cool or remove at least a portion of the heat from the process stream flowing therethrough. The heat exchanger 134 may be or include any device capable of at least partially cooling or reducing the temperature of the process stream flowing therethrough. Illustrative heat exchangers may include, but are not limited to, a direct contact heat exchanger, a cooler, a trim cooler, a mechanical refrigeration unit, or the like, or any combination thereof. In at least one embodiment, the heat exchanger 134 may be fluidly coupled with and/or in thermal communication with the compression assembly 104. For example, the heat exchanger 134 may be fluidly coupled with at least one of the coolers 128, 130, and/or at least one of the compressor stages 114, 116 of the compression assembly 104. As illustrated in FIG. 1, the heat exchanger 134 may be fluidly coupled with and disposed downstream from the second cooler 130 via lines 218, 220, and 222. The heat exchanger 134 may also be fluidly coupled with the conditioning assembly 110 and/or the natural gas source 102. For example, as illustrated in FIG. 1, the heat exchanger 134 may be fluidly coupled with and disposed downstream from the separator 132 via lines 220, 222, and 224.

In at least one embodiment, the heat exchanger 134 may be fluidly coupled with and/or in thermal communication with a chiller 136 of the cooling assembly 106. For example, as illustrated in FIG. 1, the heat exchanger 134 may be fluidly coupled with the chiller 136 via a cooling line 225 and a return line 226. The chiller 136 may be configured to cool a process fluid, such as a refrigerant, and direct the refrigerant to the heat exchanger 134 via the cooling line 225. The heat exchanger 134 may receive the refrigerant from the chiller 136 via the cooling line 225, and transfer the heat from the process stream flowing therethrough to the refrigerant to thereby reduce the temperature of the process stream and/or the natural gas contained therein. The heated refrigerant may be directed back to the chiller 136 via the return line 226 and subsequently cooled therein. While FIG. 1 illustrates the chiller 136 fluidly coupled with the heat exchanger 134, it may be appreciated that the chiller 136 may also be fluidly coupled with and/or in thermal communication with any of the heat exchangers and/or coolers of the system 100, and configured to deliver the refrigerant to the heat exchangers and/or coolers of the system 100. For example, the chiller 136 may be fluidly coupled with and/or in thermal communication with one or more of the coolers 128, 130 of the compression assembly 104. In another embodiment, the heat exchanger 134 may not be fluidly coupled with the chiller 136. Accordingly, the heat exchanger 134 may not be configured to receive the refrigerant from the chiller 136 to cool the process stream flowing therethrough. For example, the heat exchanger 134 may be configured to receive a process stream from one or more portions and/or assemblies of the system 100. In an exemplary embodiment, the heat exchanger 134 may be configured to receive a process stream from the liquefaction assembly 108 to cool the process stream flowing therethrough.

In at least one embodiment, the chiller 136 may be or include a vapor absorption chiller or non-mechanical chiller configured to receive and be driven by heat (e.g., waste heat, solar heat, etc.). Illustrative non-mechanical chillers may include, but are not limited to, ammonia absorption chillers, lithium bromide absorption chillers, and the like. In another embodiment, the chiller 136 may be a vapor compression chiller or mechanical chiller configured to receive and be driven by electrical energy. For example, as illustrated in FIG. 1, the chiller 136 may be a mechanical chiller operatively coupled with the generator 126 of the power generation system 122 via line 228 and configured to receive and be driven by electrical energy from the generator 126. The mechanical chiller 136 may include a compressor (not shown) and an electric motor (not shown) operatively coupled with the generator 126 and configured to drive the compressor. Accordingly, in an exemplary embodiment, no heat (e.g., waste heat) may be used to drive or operate the mechanical chiller 136. In at least one embodiment, utilizing the mechanical chiller 136 may provide a relatively higher coefficient of performance as compared to the non-mechanical chiller. Illustrative mechanical chillers may include, but are not limited to, ammonia-based mechanical chillers, propane-based ammonia chillers, and the like. It may be appreciated that the propane-based ammonia chillers may be capable of cooling the refrigerant to a relatively lower temperature than the ammonia-based mechanical chillers.

In at least one embodiment, the liquefaction assembly 108 may include one or more heat exchangers (three are shown 140, 142, 144) and one or more expansion elements (two are shown 146, 148) fluidly coupled with one or more of the heat exchangers 140, 142, 144. As further described herein, one or more of the expansion elements 146, 148 may be configured to receive and expand one or more process streams to decrease the temperature and pressure of the process streams and thereby generate one or more refrigeration streams. The refrigeration streams generated by the expansion elements 146, 148 may be directed to one or more of the heat exchangers 140, 142, 144 fluidly coupled therewith to cool the process stream flowing therethrough. For example, the heat exchangers 140, 142, 144 may receive the refrigeration streams and transfer heat from the process streams to the refrigeration streams to thereby cool the process streams.

As illustrated in FIG. 1, a first heat exchanger 140 of the liquefaction assembly 108 may be fluidly coupled with and disposed downstream from the heat exchanger 134 of the cooling assembly 106 via line 230, and a second heat exchanger 142 of the liquefaction assembly 108 may be fluidly coupled with and disposed downstream from the first heat exchanger 140 of the liquefaction assembly 108 via line 234. As further illustrated in FIG. 1, the second heat exchanger 142 may also be fluidly coupled with and disposed upstream of the first heat exchanger 140 via line 236. In at least one embodiment, a third heat exchanger 144 may be fluidly coupled with and disposed downstream from the natural gas source 102 and/or the separator 132, and may further be fluidly coupled with and disposed downstream from the second cooler 130. For example, as illustrated in FIG. 1, the third heat exchanger 144 may be fluidly coupled with and disposed downstream from the separator 132 via lines 224, 220, and 240, and may further be disposed downstream from the second cooler 130 via lines 218, 220, and 240. In at least one embodiment, the third heat exchanger 144 may be configured to combine the process stream flowing therethrough with the process stream in line 234, upstream of the second heat exchanger 142. For example, as illustrated in FIG. 1, the third heat exchanger 144 may be fluidly coupled with and disposed upstream of the second heat exchanger 142 via line 254.

In at least one embodiment, a valve 138, such as a flow control valve, may be fluidly coupled with lines 220, 222, and 240, and configured to control a flow of the process stream flowing therethrough. For example, the valve 138 may be configured to selectively control the flow of the process stream from line 220 to lines 222 and 240. In an exemplary embodiment, the valve 138 may be a three-way flow control valve configured to selectively control the flow or the distribution of the flow of the process stream from line 220 to lines 222 and 240. As further described herein, the valve 138 may be modulated or actuated to control the cooling and/or heating of the process stream flowing through the third heat exchanger 144.

As previously discussed, one or more of the expansion elements 146, 148 may be fluidly coupled with one or more of the heat exchangers 140, 142, 144. For example, as illustrated in FIG. 1, a first expansion element 146 may be fluidly coupled with and disposed downstream from the first heat exchanger 140 via line 242. The first expansion element 146 may also be fluidly coupled with and disposed upstream of the second heat exchanger 142 via line 244. As further illustrated in FIG. 1, a second expansion element 148 may be fluidly coupled with and disposed downstream from the second heat exchanger 142 via line 246.

In at least one embodiment, one or more of the expansion elements 146, 148 may be or include any device capable of converting a pressure and/or enthalpy drop in the process stream into mechanical energy. The expansion elements 146, 148 may also be or include any device capable of expanding the process stream to decrease the temperature and the pressure of the process stream flowing therethrough. Illustrative expansion elements 146, 148 may include, but are not limited to, a turbine or turbo-expander, a geroler, a gerotor, an expansion valve, such as a Joule-Thomson (JT) valve, or the like, or any combination thereof.

As illustrated in FIG. 1, the first expansion element 146 may be a turbo-expander configured to receive and expand a portion of the process stream from the first heat exchanger 140 to thereby decrease the temperature and pressure of the process stream flowing therethrough. In at least embodiment, the turbo-expander 146 may be configured to convert the pressure drop of the process stream flowing therethrough to mechanical energy. As further described herein, the mechanical energy provided or generated by the turbo-expander 146 may be utilized to drive one or more devices (e.g., generator, alternator, pump, compressor, etc.). While FIG. 1 illustrates the turbo-expander 146 fluidly coupled with and disposed downstream from the first heat exchanger 140, it may be appreciated that the turbo-expander 146 may be fluidly coupled with and disposed downstream from or upstream of any of the remaining heat exchangers 142, 144 of the liquefaction assembly 108. For example, the turbo-expander 146 may be fluidly coupled with and disposed downstream from the second heat exchanger 142, and/or the third heat exchanger 144.

In at least one embodiment, the turbo-expander 146 may be coupled with and configured to drive a power generator (not shown) configured to convert the mechanical energy from the turbo-expander 146 into electrical energy. Illustrative power generators may include, but are not limited to, a generator, an alternator, a motor, or the like, or any combination thereof. The electrical energy provided or generated by the power generator may be utilized to drive one or more devices or components of the system 100 to thereby increase the efficiency of the system 100. For example, the electrical energy from the power generator may be utilized (e.g., as supplemental energy) to drive the electric motor 118 of the compression assembly 104.

In another embodiment, the turbo-expander 146 may be operatively coupled with and configured to drive a compressor 150. For example, as illustrated in FIG. 1, the turbo-expander 146 may be coupled with the compressor 150 via a driveshaft 152 and configured to deliver the mechanical energy (e.g., rotational energy) to the compressor 150 via the driveshaft 152. The compressor 150 may be configured to utilize the mechanical energy from the turbo-expander 146 to compress the process stream flowing therethrough. In at least one embodiment, the compressor 150 may be fluidly coupled with one or more of the heat exchangers 140, 142, 144 of the liquefaction assembly 108. For example, as illustrated in FIG. 1, the compressor 150 may be fluidly coupled with and disposed downstream of the first heat exchanger 140 via line 250. In at least one embodiment, the compressor 150 may be configured to compress the process stream to reduce the amount of energy that may be required to compress the process stream in the compression assembly 104. For example, the compressor 150 may be fluidly coupled with the compression assembly 104 and configured to deliver the compressed process stream thereto. As illustrated in FIG. 1, the compressor 150 may be fluidly coupled with and disposed upstream of the first compressor stage 114 of the compression assembly 104 via line 252 and configured to deliver the compressed process stream thereto.

As illustrated in FIG. 1, the second expansion element 148 may be or include an expansion valve, such as a JT valve, configured to receive and expand a portion of the process stream from the second heat exchanger 142. The expansion valve 148 may expand the process stream from the second heat exchanger 142 to thereby decrease the temperature and pressure of the process stream from the second heat exchanger 142. As further described herein, the expansion of the process stream through the expansion valve 148 may flash the process stream into a two-phase fluid including a gaseous or vapor phase and a liquid phase (e.g., the LNG).

As previously discussed, the natural gas in the process stream may include a mixture of one or more hydrocarbons (e.g., methane, ethane, propane, butanes, pentanes, etc.) and one or more non-hydrocarbons (e.g., water, CO₂, etc.), and in one or more portions or assemblies of the system 100, at least a portion of the natural gas may be compressed, cooled, and/or condensed to the liquid phase. In at least one embodiment, the relatively high molecular weight hydrocarbons (e.g., ethane, propane, etc.) contained in the natural gas may be condensed to the liquid phase before the relatively low molecular weight hydrocarbons (e.g., methane). For example, the relatively high molecular weight hydrocarbons contained in the natural gas, such as ethane and propane, may have a higher boiling point and/or lower vapor pressure than the relatively low molecular weight hydrocarbons, such as methane. Accordingly, the ethane and propane may condense to the liquid phase while the methane may remain in a gaseous phase.

In at least one embodiment, the system 100 may include one or more liquid separators (two are shown 158, 160), such as scrubbers, configured to remove or separate at least a portion of the relatively high molecular weight hydrocarbons in the liquid phases, such as natural gas liquids (NGLs), from the process stream flowing therethrough to thereby provide a relatively drier process stream. For example, as illustrated in FIG. 1, a first liquid separator 158 may be fluidly coupled with line 242 upstream of the turbo-expander 146 and configured to remove the NGLs from the natural gas in the process stream flowing therethrough to thereby provide a relatively drier process stream to the turbo-expander 146. In an exemplary embodiment, the NGLs separated from the process stream by the first liquid separator 158 may contain hydrocarbons having a relatively higher boiling point and/or relatively lower vapor pressure than methane. For example, the NGLs separated from the process stream in the first liquid separator 158 may include hydrocarbons having a relatively higher molecular weight than methane, such as ethane, propane, and the like.

In another embodiment, one or more of the liquid separators 158, 160 may be configured to separate the LNG produced in the system 100. For example, as previously discussed, the expansion of the process stream through the expansion valve 148 may flash the process stream into the two-phase fluid including the vapor phase and the liquid phase, or the LNG. Accordingly, a second liquid separator 160 may be fluidly coupled with and disposed downstream from the expansion valve 148 via line 248 to separate the LNG from the two-phase fluid. As further illustrated in FIG. 1, the second liquid separator 160 may be fluidly coupled with and disposed upstream of the third heat exchanger 144 via line 232. In at least one embodiment, as further described herein, the second liquid separator 160 may be configured to direct a process stream (i.e., the second refrigeration stream) containing the natural gas in the vapor phase to the third heat exchanger 144 via line 232 to cool the process stream flowing through the third heat exchanger 144 from line 240 to 254.

In at least one embodiment, the system 100 may include a storage tank 154 configured to receive and store the LNG produced in the system 100. For example, as illustrated in FIG. 1, the storage tank 154 may be fluidly coupled with and disposed downstream from the second liquid separator 160 via line 314 and configured to receive and store the liquid phase or the LNG therefrom. The storage tank 154 may be or include any container capable of storing the LNG. Illustrative storage tanks may include, but are not limited to, cryogenic storage tanks, vessels, a Dewar-type vessel, or any other container capable of storing the LNG.

In at least one embodiment, the storage tank 154 may be configured to store the natural gas at a designed storage pressure. In an exemplary embodiment, the designed storage pressure of the storage tank 154 may be from a low of about 100 kPa, about 150 kPa, about 175 kPa, or about 190 kPa to a high of about 210 kPa, about 225 kPa, about 250 kPa, about 300 kPa, or greater. For example, the designed storage pressure of the storage tank 168 may be from about 100 kPa to about 300 kPa, about 150 kPa to about 250 kPa, about 175 kPa to about 225 kPa, or about 190 kPa to about 210 kPa. In at least one embodiment, the storage tank 154 may have a maximum storage pressure or a maximum allowable working pressure (MAWP) rating. The MAWP of the storage tank 154 may be greater than about 250 kPa, greater than about 300 kPa, greater than about 350 kPa, greater than about 400 kPa, greater than about 500 kPa, or greater than about 600 kPa.

In an exemplary operation of the system 100, a process stream containing natural gas may be introduced into the system 100 from the natural gas source 102 via line 202. The process stream may be introduced into line 202 at a relatively high pressure (e.g., from about 2,800 kPa to about 10,300 kPa). The process stream may also be introduced into line 202 at a relatively low temperature (e.g., about 5° C. to about 25° C.) or a relatively high temperature (e.g., about 25° C. or greater). In an exemplary embodiment, the process stream may be introduced into line 202 at ambient temperature. As previously discussed, the separator 132 of the conditioning assembly 110 and/or the adsorbent contained therein may be configured to absorb the non-hydrocarbons (e.g., CO₂ and/or water) at a predetermined separation temperature and/or a predetermined separation pressure. Accordingly, in an exemplary embodiment, the process stream in line 202 may be at the predetermined separation temperature and/or the predetermined separation pressure.

In at least one embodiment, the process stream in line 202 may be directed to and through the separator 132 to separate at least a portion of the non-hydrocarbons (e.g., CO₂ and/or water) contained therein. For example, the separator 132 may separate water and/or CO₂ from the natural gas in the process stream to thereby provide the process stream in line 224, downstream the separator 132, with “clean” natural gas. The separator 132 may also separate water and/or CO₂ from the natural gas in the process stream to increase the relative concentration of the hydrocarbons. The terms “clean” natural gas or “clean” process stream refer to any natural gas or process stream that has been processed by the separator 132 to remove at least a portion of the non-hydrocarbons contained therein. In one embodiment, the “clean” natural gas or “clean” process stream include any natural gas or process stream having a concentration of CO₂ from a low of about 1%, about 2%, about 3%, about 4%, or about 5% to a high of about 10%, about 12%, about 14%, about 16%, about 18%, or about 20%. For example, the “clean” natural gas or the “clean” process stream may have a concentration of CO₂ less than 20%, less than about 18%, less than about 15%, less than about 10%, less than about 5%, less than about 4%, less than about 2%, or less than about 1%. In another embodiment, the “clean” natural gas or “clean” process stream may include any natural gas or process stream having a concentration of water from a low of about 1%, about 2%, about 3%, about 4%, or about 5% to a high of about 10%, about 12%, about 14%, about 16%, about 18%, or about 20%. For example, the “clean” natural gas or the “clean” process stream may have a concentration of water less than about 20%, less than about 18%, less than about 15%, less than about 10%, less than about 5%, less than about 4%, less than about 2%, or less than about 1%.

In at least one embodiment, the process stream from the separator 132 and/or the natural gas source 102 may be combined with the process stream in line 218 downstream the second cooler 130 via line 224. Accordingly, the process stream in line 220 may include a mixture of the natural gas from the separator 132 and the natural gas from the second cooler 130. In at least one embodiment, combining the process stream from the separator 132 with the process stream in line 218 may decrease the temperature of the process stream in line 220. For example, the process stream in line 218 may have a relatively lower temperature than the process stream in line 224. Accordingly, combining the relatively warmer process stream in line 224 with the relatively cooler process stream in line 218 may decrease the temperature of the process stream in line 220.

In at least one embodiment, at least a portion of the process stream in line 220 may be directed to the heat exchanger 134 of the cooling assembly 106 via the valve 138 and line 222 and subsequently cooled therein. As further discussed herein, the remaining portions of the process stream in line 220 may be directed to the third heat exchanger 144 of the liquefaction assembly 108 via the valve 138 and line 240. The heat exchanger 134 may precool the process stream by absorbing at least a portion of the heat from the process stream and directing the precooled process stream to the first heat exchanger 140 of the liquefaction assembly 108 via line 230. In an exemplary embodiment, the heat exchanger 134 may precool the process stream to a temperature less than about −32° C. or less than about −39° C.

As illustrated in FIG. 1, the process stream from the heat exchanger 134 may be directed to the first heat exchanger 140 of the liquefaction assembly 108 via line 230 and subsequently cooled therein. In at least one embodiment, a refrigeration stream (i.e., the first refrigeration stream) may be directed to the first heat exchanger 140 via line 236 to cool the process stream from line 230. The first heat exchanger 140 may transfer heat from the process stream to the first refrigeration stream and direct at least a portion of the cooled process stream to the second heat exchanger 142 via line 234. As further described herein, at least a portion of the cooled process stream from the first heat exchanger 140 may also be directed to the turbo-expander 146 via line 242 to generate the first refrigeration stream. The second heat exchanger 142 may absorb at least a portion of the heat in the process stream and direct the cooled process stream to the expansion valve 148 via line 246. A refrigeration stream (i.e., the first refrigeration stream) may be directed to the second heat exchanger 142 via line 244 to cool the process stream from line 234. In at least one embodiment, the second heat exchanger 142 may cool at least a portion of the natural gas in the process stream to a liquid phase. For example, at least a portion of the process stream in line 246 may contain the CCNG or the LNG.

In at least one embodiment, the expansion valve 148 may receive and expand the process stream from the second heat exchanger 142 to decrease the temperature and pressure of the process stream in line 248. For example, the expansion valve 148 may decrease the pressure of the process stream to the designed storage pressure of the storage tank 154. In another example, the expansion of the process stream through the expansion valve 148 may provide the process stream in line 248 with a temperature from a low of about −160° C. to a high of about −150° C. As previously discussed, expanding the process stream through the expansion valve 148 may flash the process stream into the two-phase fluid including the vapor phase and the liquid phase, or the LNG. In an exemplary embodiment, about 15% of the process stream may be in the vapor phase and about 85% of the process stream may be in the liquid phase. Accordingly, the process stream in line 248 may include the liquid phase, or the LNG, and the vapor phase. The process stream in line 248, including the LNG and the vapor phase, may be directed to the second liquid separator 160 to separate at least a portion of the LNG from the vapor phase. The LNG separated in the second liquid separator 160 may be directed to the storage tank 154 via line 314 and stored therein.

In at least one embodiment, the vapor phase from the second liquid separator 160 may be directed to any one or more of the heat exchangers 140, 142, 144 of the liquefaction assembly 108, as the second refrigeration stream, to cool the process stream flowing therethrough. For example, as illustrated in FIG. 1, the second refrigeration stream may be directed to the third heat exchanger 144 via line 232 to cool or absorb the heat from the process stream flowing therethrough. As further described herein, the heated second refrigeration stream from the third heat exchanger 144 may be directed to one or more portions or assemblies of the system 100 via line 238.

In at least one embodiment, the heating of the second refrigeration stream in the third heat exchanger 144 and/or the cooling of the process stream in the third heat exchanger 144 may be controlled or regulated by the flow of the process stream to and through the third heat exchanger 144 from the valve 138. For example, the process stream in line 240 may have a relatively higher temperature than the second refrigeration stream flowing through the third heat exchanger 144, and increasing the flow of the relatively warmer process stream to and through the third heat exchanger 144 via line 240 may increase the degree in which the second refrigeration stream may be heated in the third heat exchanger 144. Similarly, decreasing the flow of the relatively warmer process stream to and through the third heat exchanger 144 via line 240 may decrease the degree in which the second refrigeration stream may be heated in the third heat exchanger 144. Accordingly, the valve 138 may be actuated or modulated to increase or decrease the flow of the process stream to the third heat exchanger 144 via line 240 to correspondingly increase or decrease the degree in which the second refrigeration stream may be heated in the third heat exchanger 144.

As previously discussed, the heated second refrigeration stream from the third heat exchanger 144 may be directed to one or more portions or assemblies of the system 100 via line 238. It may be appreciated that the ability to control the temperature of the second refrigeration stream in line 238 with the valve 138 may allow the second refrigeration stream to be selectively injected or combined with the process stream in one or more portions or assemblies of the system 100. For example, as illustrated in FIG. 1, the second refrigeration stream in line 238 may be combined with the process stream in line 218, downstream from the second cooler 130 via line 306. In another example, illustrated in FIG. 1, the second refrigeration stream in line 238 may be combined with the process stream in line 252, downstream from the compressor 150, via line 308. In yet another example, the second refrigeration stream in line 238 may be combined with the process stream in line 214, upstream of the second compressor stage 116, via line 310. In another embodiment, the second refrigeration stream in line 238 may be directed to the power generation system 122 via line 312 to provide supplemental fuel to the internal combustion engine 124. In at least one embodiment, the second refrigeration stream in line 238 may be compressed in an auxiliary compressor (not shown) or another compressor stage (not shown) of the compression assembly 104 before being directed to the one or more portions or assemblies of the system 100.

In at least one embodiment, the pressure of the second refrigeration stream in line 312 may be greater than a designed inlet pressure of the internal combustion engine 124. Accordingly, as illustrated in FIG. 1, a flow control valve 164 may be fluidly coupled with line 312 and configured to control a flow or flowrate of the second refrigeration stream flowing therethrough and/or to reduce the pressure of the second refrigeration stream to the designed inlet pressure of the internal combustion engine 124. As further illustrated in FIG. 1, another flow control valve 156 may be fluidly coupled with line 204 and configured to control the flowrate and/or reduce the pressure of the natural gas from the natural gas source 102 to the internal combustion engine 124.

As previously discussed, the internal combustion engine 124 may receive the regeneration gas from the separator 132 via line 206, the second refrigeration stream from the third heat exchanger 144 via line 312, and the natural gas from the natural gas source 102 via line 204. In at least one embodiment, the flow of the fuel from the various fuel sources (e.g., the separator 132, the third heat exchanger 144, and the natural gas source 102) to the internal combustion engine 124 may be controlled to increase the efficiency of the system 100. For example, the internal combustion engine 124 may preferentially combust or utilize the regeneration gas from the separator 132 before utilizing the second refrigeration stream from line 312 and/or the natural gas from the natural gas source 102. In another example, the internal combustion engine 124 may preferentially combust or utilized the second refrigeration stream from line 312 before utilizing the natural gas from the natural gas source 102.

As previously discussed, at least a portion of the process stream from the first heat exchanger 140 may be utilized to generate the first refrigeration stream. For example, as illustrated in FIG. 1, a portion of the process stream from the first heat exchanger 140 may be directed to the turbo-expander 146 via line 242 to generate the first refrigeration stream. The first liquid separator 158 fluidly coupled with line 242 upstream of the turbo-expander 146 may remove or separate at least a portion of the condensed high molecular weight hydrocarbons (e.g., the NGLs) from the process stream to provide a relatively drier process stream to the turbo-expander 146. The turbo-expander 146 may expand the process stream from the second heat exchanger 140 to decrease the temperature and pressure of the process stream and thereby generate the first refrigeration stream in line 244. For example, the first refrigeration stream in line 244 may have a temperature from a low of about −140° C. to a high of about −125° C. In an exemplary embodiment, the turbo-expander 146 may have an expansion ratio of about 10:1. For example, the process stream expanded through the turbo-expander 146 may be subjected to a pressure reduction of about 10:1.

In at least one embodiment, the first refrigeration stream in line 244 may be directed to any one or more of the heat exchangers 140, 142, 144 of the liquefaction assembly 108. For example, as illustrated in FIG. 1, the first refrigeration stream may be directed to the second heat exchanger 142 via line 244 to absorb the heat from the process stream flowing therethrough from line 234 to line 246. In at least one embodiment, the first refrigeration stream from the second heat exchanger 142 may provide additional cooling to one or more of the remaining heat exchangers 140, 144. For example, as illustrated in FIG. 1, the first refrigeration stream from the second heat exchanger 142 may be directed to and through the first heat exchanger 140 from line 236 to line 250 to absorb the heat from the process stream flowing through the first heat exchanger 140. In an exemplary embodiment, the first recycle stream in line 250 may have a temperature substantially equal to or less than the temperature of the process stream in line 230.

In at least one embodiment, the first refrigeration stream in line 250 may contain “clean” natural gas and may be directed to the compression assembly 104 as a recycle stream. For example, the first refrigeration stream in line 250 may be directed to the compression assembly 104 as the recycle stream via line 252 and subsequently compressed therein. In at least one embodiment, the first refrigeration stream in line 250 may be compressed to provide the recycle stream. For example, as illustrated in FIG. 1, the first refrigeration stream in line 250 may be compressed in the compressor 150 to provide the recycle stream in line 252. The compressor 150 may compress the first refrigeration stream to provide the recycle stream in line 252 with a pressure from a low of about 550 kPa to a high of about 580 kPa, or greater. In at least one embodiment, compressing the first refrigeration stream in the compressor 150 may generate heat (e.g., the heat of compression) to thereby increase the temperature of the recycle stream in line 252. For example, the recycle stream in line 252 may have a temperature substantially equal to or greater than the temperature of the process stream in line 230.

In at least one embodiment, the compressor 150 may be configured to compress the recycle stream to a selected inlet pressure of one or more compressor stages 114, 116 of the compression assembly 104. For example, as illustrated in FIG. 1, the compressor 150 may be fluidly coupled with the first compressor stage 114 via line 252 and configured to compress the recycle stream to the selected inlet pressure of the first compressor stage 114. In at least one embodiment, the selected inlet pressure of the compressor stages 114, 116 may be determined by one or more operating parameters of the compressor 112. The first compressor stage 114 may receive and compress the recycle stream from line 252 and direct the compressed recycle stream to the first cooler 128 via line 212. In at least one embodiment, the first compressor stage 114 may compress the recycle stream to a pressure from a low of about 1,000 kPa to a high of about 1,700 kPa. Compressing the recycle stream in the first compressor stage 114 may generate heat (e.g., the heat of compression) to thereby increase the temperature of the recycle stream in line 212 from a low of about 55° C. to a high of about 85° C. or greater.

In at least one embodiment, the recycle stream from the first compressor stage 114 may be directed to the first cooler 128 via line 212 and subsequently cooled therein. The first cooler 128 may cool the recycle stream to a temperature from a low of about 25° C. to a high of about 55° C. The cooled recycle stream from the first cooler 128 may be directed to the second compressor stage 116 via line 214. The second compressor stage 116 may receive and compress the recycle stream from the first cooler 128 and direct the compressed recycle stream to the second cooler 130 via line 216. The second compressor stage 116 may compress the recycle stream to a pressure from a low of about 4,000 kPa to a high of about 4,100 kPa. Compressing the recycle stream in the second compressor stage 116 may generate heat (e.g., the heat of compression) to thereby increase the temperature of the recycle stream in line 216. For example, the recycle stream in line 216 may have a temperature from a low of about 115° C. to a high of about 185° C. or greater. The second cooler 130 may receive the compressed recycle stream from the second compressor stage 116 and cool the recycle stream to a temperature from a low of about 25° C. to a high of about 55° C.

In at least one embodiment, the recycle stream from the second cooler 130 may be combined with the process stream from the separator 132 and/or the natural gas source 102 and subsequently directed to line 220. As previously discussed, the valve 138 may direct at least a portion of the process stream in line 220 to and through the third heat exchanger 144 via lines 240 and 254. The portion of the process stream may be cooled in the third heat exchanger 144 and subsequently combined with the process stream in line 234, upstream of the second heat exchanger 142. It may be appreciated that cooling the process stream in the third heat exchanger 144 may allow the system 100 to recover the energy or work utilized to cool the natural gas to the LNG, thereby increasing the efficiency of the system 100.

The temperatures, pressures, and flowrates of the process stream in one or more portions or lines of the system 100 are shown in Table 1. Table 1 provides the temperatures, pressures, and flowrates for producing about 93 kiloliters (kl) of the LNG per day. It may be appreciated that all numerical values and ranges disclosed herein and in Table 1 are approximate values and ranges for the temperatures, pressures, and flowrates, regardless of whether “about” is used in connection therewith. Accordingly, all the numerical values and numerical ranges disclosed herein and in Table 1 may vary (i.e., increase or decrease) by 1 percent (%), 2%, 3%, 5%, 8%, 10%, 15%, 20%, 25%, 30%, 35%, 40%, 50%, 70%, or 80%. For example, disclosing that a process stream may have a temperature of about 100° C. also specifically discloses that the process stream may have a temperature of about 90° C. or about 110° C. (i.e., varying by 10%). In another example, disclosing that a process stream may have a pressure of about 100 kPa also specifically discloses that the process stream may have a pressure of about 90 kPa or about 110 kPa (i.e., varying by 10%). In yet another example, disclosing that a process stream may have a pressure from a low of about 100 kPa to a high of about 200 kPa also specifically discloses that the process stream may have pressure from a low of about 90 kPa to a high of about 180 kPa, a low of about 90 kPa to a high of about 220 kPa, a low of about 110 kPa to a high of about 180 kPa, or a low of about 110 kPa to a high of about 220 kPa (i.e., varying by 10%). Further, when a numerical range is disclosed herein, any numerical value falling within the range is also specifically disclosed. For example, disclosing that the process stream may have a temperature from a low of about 100° C. to a high of about 105° C. specifically discloses that the process stream may have a temperature of about 100° C., 101° C., 102° C., 103° C., 104° C., or 105° C.

TABLE 1

| Reference | Flowrate | Temperature | Pressure |
|---|---|---|---|
| Points | (kg/hr) | (° C.) | (kPa) |
| 258 | 4,535 | 171 | 4,080 |
| 260 | 4,535 | 40 | 4,075 |
| 262 | 1,356 | 16 | 4,137 |
| 264 | 5,846 | 30 | 4,100 |
| 266 | 1,356 | 30 | 4,100 |
| 268 | 1,356 | −30 | 4,100 |
| 270 | 1,356 | −40 | 4,100 |
| 272 | 5,847 | −56 | 4,054 |
| 276 | 4,535 | −130 | 4,040 |
| 278 | 179 | −145 | 338 |
| 280 | 176 | −145 | 331 |
| 282 | 176 | 16 | 331 |
| 284 | 1,311 | −56 | 4,054 |
| 286 | 4,535 | −135 | 414 |
| 288 | 4,535 | −78 | 379 |
| 290 | 4,535 | −36 | 317 |
| 292 | 4,535 | 11 | 565 |
| 294 | 4,535 | 68 | 1,069 |
| 296 | 4,535 | 41 | 1,062 |
| 298 | 45 | 16 | 4,068 |
| 300 | 45 | −141 | 4,068 |
| 302 | 1,177 | −155 | 338 |

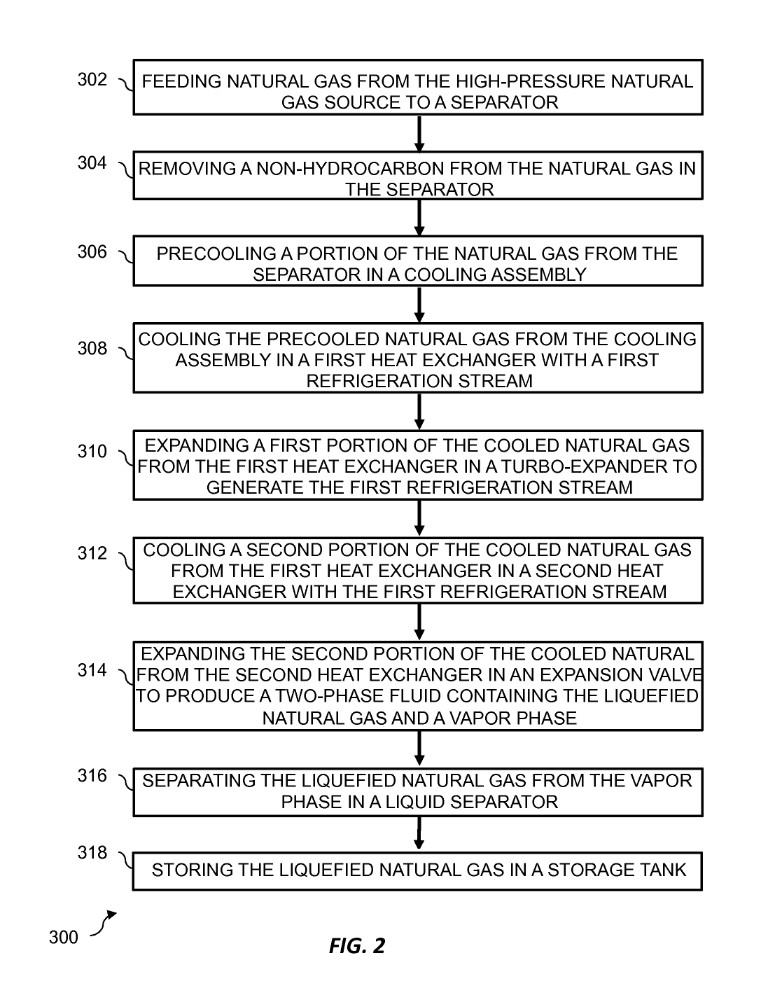

FIG. 2 illustrates a flowchart of a method 300 for producing liquefied natural gas from a high-pressure natural gas source, according to one or more embodiments. The method 300 may include feeding natural gas from the high-pressure natural gas source to a separator, as shown at 302. The method 300 may also include removing a non-hydrocarbon from the natural gas in the separator, as shown at 304. The method 300 may further include precooling a portion of the natural gas from the separator in a cooling assembly, as shown at 306. The method 300 may also include cooling the precooled natural gas from the cooling assembly in a first heat exchanger with a first refrigeration stream, as shown at 308. The method 300 may also include expanding a first portion of the cooled natural gas from the first heat exchanger in a turbo-expander to generate the first refrigeration stream, as shown at 310. The method 300 may further include cooling a second portion of the cooled natural gas from the first heat exchanger in a second heat exchanger with the first refrigeration stream, as shown at 312. The method 300 may also include expanding the second portion of the cooled natural from the second heat exchanger in an expansion valve to produce a two-phase fluid containing the liquefied natural gas and a vapor phase, as shown at 314. The method 300 may also include separating the liquefied natural gas from the vapor phase in a liquid separator, as shown at 316. The method 300 may also include storing the liquefied natural gas in a storage tank, as shown at 318.

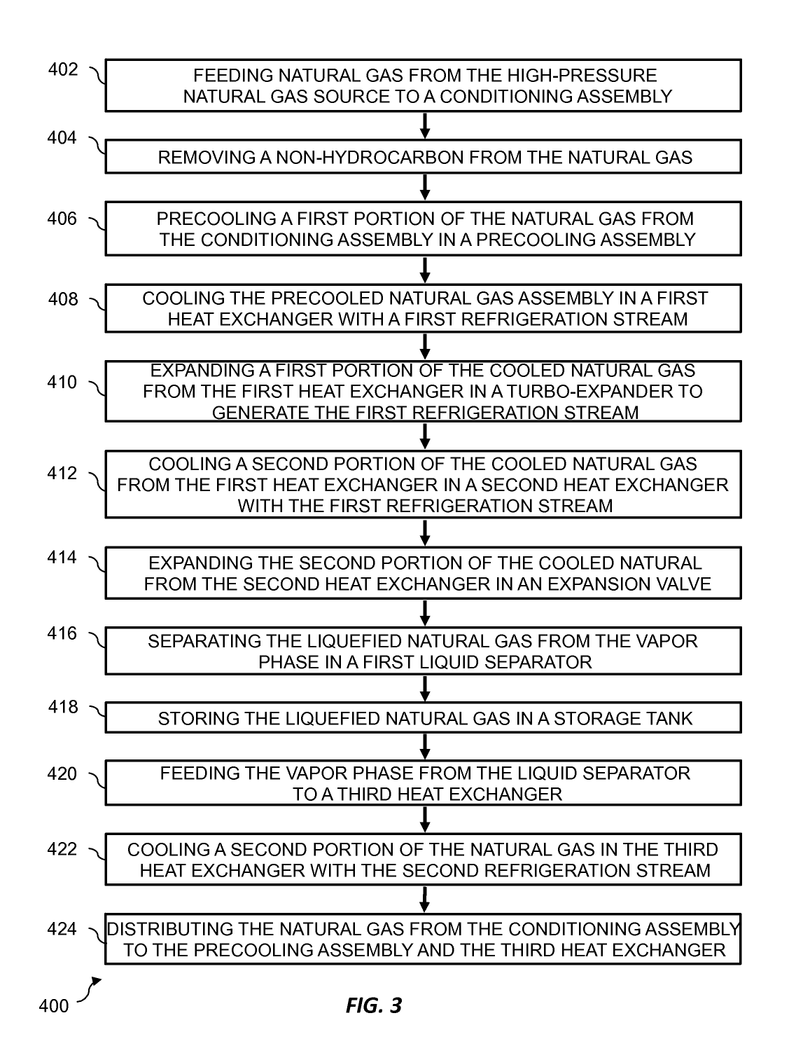

FIG. 3 illustrates a flowchart of another method 400 for producing liquefied natural gas from a high-pressure natural gas source, according to one or more embodiments. The method 400 may include feeding natural gas from the high-pressure natural gas source to a conditioning assembly, as shown at 402. The method 400 may also include removing a non-hydrocarbon from the natural gas in the conditioning assembly, as shown at 404. The method 400 may further include precooling a first portion of the natural gas from the conditioning assembly in a precooling assembly, as shown at 406. The method 400 may also include cooling the precooled natural gas from the precooling assembly in a first heat exchanger with a first refrigeration stream, as shown at 408. The method 400 may also include expanding a first portion of the cooled natural gas from the first heat exchanger in a turbo-expander to generate the first refrigeration stream, as shown at 410. The method 400 may further include cooling a second portion of the cooled natural gas from the first heat exchanger in a second heat exchanger with the first refrigeration stream, as shown at 412. The method 400 may also include expanding the second portion of the cooled natural from the second heat exchanger in an expansion valve to produce a two-phase fluid containing the liquefied natural gas and a vapor phase, as shown at 414. The method 400 may also include separating the liquefied natural gas from the vapor phase in a first liquid separator, as shown at 416. The method 400 may also include storing the liquefied natural gas in a storage tank, as shown at 418. The method 400 may further include feeding the vapor phase from the liquid separator to a third heat exchanger to provide a second refrigeration stream to the third heat exchanger, as shown at 420. The method 400 may also include cooling a second portion of the natural gas from the conditioning assembly in the third heat exchanger with the second refrigeration stream, as shown at 422. The method 400 may also include distributing the natural gas from the conditioning assembly to the precooling assembly and the third heat exchanger via a flow control valve, as shown at 424.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method for producing liquefied natural gas from a high-pressure natural gas source, comprising:
feeding natural gas from the high-pressure natural gas source to a separator;
removing a non-hydrocarbon from the natural gas in the separator;
precooling a portion of the natural gas from the separator in a cooling assembly;
cooling the precooled natural gas from the cooling assembly in a first heat exchanger with a first refrigeration stream;
expanding a first portion of the cooled natural gas from the first heat exchanger in a turbo-expander to generate the first refrigeration stream;
cooling a second portion of the cooled natural gas from the first heat exchanger in a second heat exchanger with the first refrigeration stream;
expanding the second portion of the cooled natural gas from the second heat exchanger in an expansion valve to produce a two-phase fluid containing the liquefied natural gas and a vapor phase;
separating the liquefied natural gas from the vapor phase in a liquid separator; and
storing the liquefied natural gas in a storage tank.

2. The method of claim 1, further comprising at least partially separating natural gas liquids from the first portion of the cooled natural gas in another liquid separator before expanding the first portion of the cooled natural gas in the turbo-expander.

3. The method of claim 1, further comprising:
feeding the vapor phase from the liquid separator to a third heat exchanger to provide a second refrigeration stream to the third heat exchanger; and
cooling another portion of the natural gas from the separator in the third heat exchanger with the second refrigeration stream.

4. The method of claim 3, wherein cooling the another portion of the natural gas from the separator in the third heat exchanger with the second refrigeration stream comprises heating the second refrigeration stream with the another portion of the natural gas from the separator to ambient temperature.

5. The method of claim 3, further comprising feeding the another portion of the natural gas from the third heat exchanger to the second heat exchanger.

6. The method of claim 3, further comprising:
feeding the second refrigeration stream from the third heat exchanger to a power generation system; and
combusting the second refrigeration stream in the power generation system to generate electrical energy.

7. The method of claim 3, further comprising controlling the distribution of the natural gas from the separator to the cooling assembly and the third heat exchanger with a three-way flow control valve.

8. The method of claim 3, further comprising compressing the first refrigeration stream from the first heat exchanger in a compressor operatively coupled with the turbo-expander to generate a recycle stream.

9. The method of claim 8, further comprising combining the second refrigeration stream from the third heat exchanger with the recycle stream.

10. The method of claim 8, further comprising compressing the recycle stream in a compression assembly fluidly coupled with the compressor.

11. The method of claim 10, further comprising combining the second refrigeration stream from the third heat exchanger with the compressed recycle stream in the compression assembly.

12. A method for producing liquefied natural gas from a high-pressure natural gas source, comprising:
feeding natural gas from the high-pressure natural gas source to a conditioning assembly;
removing a non-hydrocarbon from the natural gas in the conditioning assembly;
precooling a first portion of the natural gas from the conditioning assembly in a precooling assembly;
cooling the precooled natural gas from the precooling assembly in a first heat exchanger with a first refrigeration stream;
expanding a first portion of the cooled natural gas from the first heat exchanger in a turbo-expander to generate the first refrigeration stream;
cooling a second portion of the cooled natural gas from the first heat exchanger in a second heat exchanger with the first refrigeration stream;
expanding the second portion of the cooled natural gas from the second heat exchanger in an expansion valve to produce a two-phase fluid containing the liquefied natural gas and a vapor phase;
separating the liquefied natural gas from the vapor phase in a first liquid separator;
storing the liquefied natural gas in a storage tank;
feeding the vapor phase from the liquid separator to a third heat exchanger to provide a second refrigeration stream to the third heat exchanger;
cooling a second portion of the natural gas from the conditioning assembly in the third heat exchanger with the second refrigeration stream; and
distributing the natural gas from the conditioning assembly to the precooling assembly and the third heat exchanger via a flow control valve.

13. A system for producing liquefied natural gas from a high-pressure natural gas source, comprising:
a separator configured to receive natural gas from the high-pressure natural gas source and separate a non-hydrocarbon from the natural gas;
a cooling assembly fluidly coupled with and disposed downstream from the separator and configured to precool the natural gas from the separator;
a first heat exchanger fluidly coupled with and disposed downstream from the cooling assembly and configured to receive a first refrigeration stream and cool the precooled natural gas from the cooling assembly with the first refrigeration stream;
a turbo-expander fluidly coupled with and disposed downstream from the first heat exchanger and configured to expand a first portion of the cooled natural gas from the first heat exchanger to generate the first refrigeration stream;
a second heat exchanger fluidly coupled with and disposed downstream from the first heat exchanger and the turbo-expander, the second heat exchanger configured to receive the first refrigeration stream from the turbo-expander and cool a second portion of the cooled natural gas from the first heat exchanger with the first refrigeration stream;
an expansion valve fluidly coupled with and disposed downstream from the second heat exchanger and configured to receive and expand the second portion of the cooled natural gas from the second heat exchanger to produce a two-phase fluid containing the liquefied natural gas and a vapor phase;
a liquid separator fluidly coupled with the expansion valve and configured to separate the liquefied natural gas from the vapor phase; and
a storage tank fluidly coupled with the liquid separator and configured to receive and store the liquefied natural gas from the liquid separator.

14. The system of claim 13, further comprising another liquid separator fluidly coupled with and disposed upstream of the turbo-expander and configured to separate natural gas liquids from the first portion of the cooled natural gas from the first heat exchanger.

15. The system of claim 13, further comprising a third heat exchanger fluidly coupled with and disposed downstream from the liquid separator and configured to receive the vapor phase from the liquid separator as a second refrigeration stream.

16. The system of claim 15, further comprising a flow control valve disposed downstream from the separator and upstream of the cooling assembly and the third heat exchanger, the flow control valve configured to control the distribution of the natural gas from the separator to the cooling assembly and the third heat exchanger.

17. The system of claim 16, wherein the third heat exchanger is fluidly coupled with and disposed upstream of the second heat exchanger.

18. The system of claim 13, further comprising a compressor operatively coupled with the turbo-expander and fluidly coupled with the first heat exchanger, the compressor configured to receive and compress the first refrigeration stream from the first heat exchanger.

19. The system of claim 18, further comprising a compression assembly fluidly coupled with and disposed downstream from the compressor.

20. The system of claim 15, further comprising a power generation system having an internal combustion engine configured to generate mechanical energy, and a generator operatively coupled with the internal combustion engine and configured to convert the mechanical energy from the internal combustion engine to electrical energy, wherein the internal combustion engine is configured to be fluidly coupled with at least one of the separator, the high-pressure natural gas source, and the third heat exchanger.
